(19) United States
(12) Patent Application Publication
(10) Pub. No.: US 2012/0020396 A1
(43) Pub. Date: Jan. 26, 2012

(54) CALIBRATION OF SMART ANTENNA SYSTEMS

(75) Inventors: Hans Thomas Höhne, Helsinki (FI); Hans-Otto Scheck, Espoo (FI); Petri Antero Jolma, Nurmijarvi (FI)

(73) Assignee: NOKIA CORPORATION, Espoo (FI)

(21) Appl. No.: 12/672,730

(22) PCT Filed: Aug. 9, 2007
(86) PCT No.: PCT/IB07/02326

§ 371 Date: Aug. 4, 2010

(51) Int. Cl. H04B 7/02

(52) U.S. Cl. 375/224

(57) ABSTRACT

The present invention relates to a method, system, apparatus, and computer pro-gram product for transmitting or receiving a plurality of time-duplexed transmission signal components via respective transmission or reception chains and respective antenna elements of a smart antenna system. A calibration signal is temporarily coupled into or from the transmission or reception chains via a selected one of the transmission or reception chains by using a portion of the transmission signal components, and a calibration signal parameter, influenced by said transmission or reception chains, is measured relative to a selected one of the transmission or reception chains. Then, a beamforming process of said smart antenna system is calibrated in response to a result of the measuring.

### FIELD OF THE INVENTION

The present invention relates to a method, system, apparatus, and computer program products for calibrating a smart or a multi-antenna system, such as multiple-input multiple-output (MIMO) system.

### BACKGROUND OF THE INVENTION

A smart antenna systems (also known as adaptive antenna system) refers to a system of antenna elements or arrays with smart signal processing algorithms that can be used to identify the direction of arrival (DOA) of a transmission signal, and use it to calculate beamforming vectors, to track and locate the antenna beam on a mobile device or target. The antenna could optionally be any sensor. Two of the main types of smart antennas include switched beam smart antennas and adaptive array smart antennas. Switched beam systems have several available fixed beam patterns. A decision is made as to which beam to access, at any given point in time, based upon the requirements of the system. Adaptive arrays allow the antenna to steer the beam to any direction of interest while simultaneously nulling interfering signals.

Beamforming is a process used to create a radiation pattern of the antenna array by adding constructively the phases of the signals in the direction of desired targets or mobile devices, and/or nulling the pattern of target or mobile devices that are undesired or interfering. Beamforming takes advantage of interference to change the directionality of the array. When transmitting, a beamformer controls the phase and relative amplitude of the signal at each transmitter, in order to create a pattern of constructive and destructive interference in the wavefront. When receiving, information from different sensors is combined in such a way that the expected pattern of radiation is preferentially observed. This can be done with a simple digital filter (e.g. finite impulse response (FIR) filter with a tapped delay line). The weights of the digital filter may also be changed adaptively, and used to provide optimal beamforming, in the sense that it reduces for example the minimum mean square error (MMSE) between a desired and an actual beampattern formed. Typical algorithms are the steepest descent, and least mean square (LMS) algorithms.

In so-called MIMO (Multiple Input Multiple Output) systems antenna arrays are used to enhance bandwidth efficiency. MIMO systems provide multiple inputs and multiple outputs for a single channel and are thus able to exploit spatial diversity and spatial multiplexing. Further information about MIMO systems can be gathered from the IEEE specifications 802.11n, 802.16-2004 and 802.16e, as well as 802.20 and 802.22 which relate to other standards. Specifically, MIMO systems have been introduced to radio systems like e.g. WiMAX (Worldwide Interoperability for Microwave Access) and are currently standardized in 3GPP for WCDMA (Wideband Code Division Multiple Access) as well as 3GPP E-UTRAN (Enhanced Universal Mobile Telecommunications System (UMTS) Terrestrial Radio Access Network), such as LTE (Long Term Evolution) or 3.9 G.

However, to provide a reliable beamforming mechanism, the phases and amplitudes of multiple transceiver chains need to be calibrated in order to allow phases and amplitudes to be aligned in a constructive fashion. Such a calibration may be necessary several times a day, as the hardware channel properties may be affected e.g. by temperature changes in the transceivers.

### SUMMARY

It is therefore an object of the present invention to provide an efficient calibration structure which can be implemented at low additional complexity.

This object is achieved by a method comprising:
transmitting or receiving a plurality of time-duplexed transmission signal components via respective transmission or reception chains and respective antenna elements of a smart antenna system;
temporarily coupling a calibration signal into or from said transmission or reception chains via a selected one of said transmission or reception chains by using a portion of said transmission signal components;
measuring a calibration signal parameter, influenced by said transmission or reception chains, relative to a selected one of said transmission or reception chains; and
calibrating a beamforming process of said smart antenna system in response to a result of said measuring.

Additionally, the above object is achieved by an apparatus comprising:
a transmitter or receiver arrangement (22, 32, 24, 34, 26, 36, 28, 38) for transmitting or receiving a plurality of time-duplexed transmission signal components via respective transmission or reception chains and respective antenna elements of a smart antenna system;
a coupling circuit (40, 50) for temporarily coupling a calibration signal into or from said transmission or reception chains via a selected one of said transmission or reception chains by using a portion of said transmission signal components;
a measuring unit (10) for measuring a calibration signal parameter, influenced by said transmission or reception chains, relative to a selected one of said transmission or reception chains; and
a calibration unit (10) for calibrating a beamforming process of said smart antenna system in response to a result of said measuring.

Further, the above object is achieved by a transmission system comprising at least one apparatus as defined above.

In addition, the above object is achieved by a respective computer program product comprising code means for producing the steps of the above methods when run on a computer device.

Accordingly, a calibration structure can be provided, which makes use of an existing transmission or reception chain, so that no separate calibration signal generator or dedicated processing chain is required and the additional complexity can be kept very low.

The portion of the transmission signal components can be a time period, code slice or frequency slice. Such an implementation can be useful for uplink transmission signal components. Uplink calibration may be performed in dependence on the result of a cell load determination. More specifically, for uplink calibration, the calibration signal may be a noise signal or a regular user signal.

Additionally or alternatively, the portion of the transmission signal components may be a signal portion specific to an antenna element, e.g. an antenna-specific pilot signal. This implementation can be useful for downlink transmission signal components.

Furthermore, the calibration may comprise generating calibration coefficients for a beamforming algorithm.

The calibration signal may be coupled to or from the respective transmission or reception chains via a switchable signal path which is coupled to the selected one of the transmission or reception chains. The switchable signal path may comprise, for example, a combining or distributing element. The coupling of the calibration signal may be performed prior to power amplification of the transmission signal components. According to a specific example, the power amplification may be switched off during uplink calibration. The coupling may be performed by using respective couplers or a calibration antenna arranged close to the antenna elements.

Further advantageous modifications or developments are defined in the dependent claims.

### BRIEF DESCRIPTION OF THE DRAWINGS

The present invention will now be described on the basis of an embodiment with reference to the accompanying drawings in which:

FIG. 1 shows a schematic diagram of a smart antenna system with an apparatus according to the embodiment;

FIG. 2 shows a sequence of symbols with dedicated pilots for four antennas;

FIG. 3 shows a schematic flow diagram of an uplink calibration procedure according to the embodiment;

FIG. 4 shows a schematic flow diagram of a downlink calibration procedure according to the embodiment; and

FIG. 5 a schematic block diagram of a computer-based implementation of the embodiment.

### DESCRIPTION OF THE EMBODIMENT

The embodiment will now be described for a wireless multi-antenna transmission system or smart antenna system, such as—but not limited to—a MIMO system for an exemplary case of four antenna elements at a transceiver unit e.g. of a base station device, such as a Node B. However, it will be apparent from the following description and is therefore explicitly stressed that the present invention can be applied to any other multi-antenna transmission system for different radio access technologies involving multi-antenna transceiver devices (e.g. base station devices, access points or other access devices).

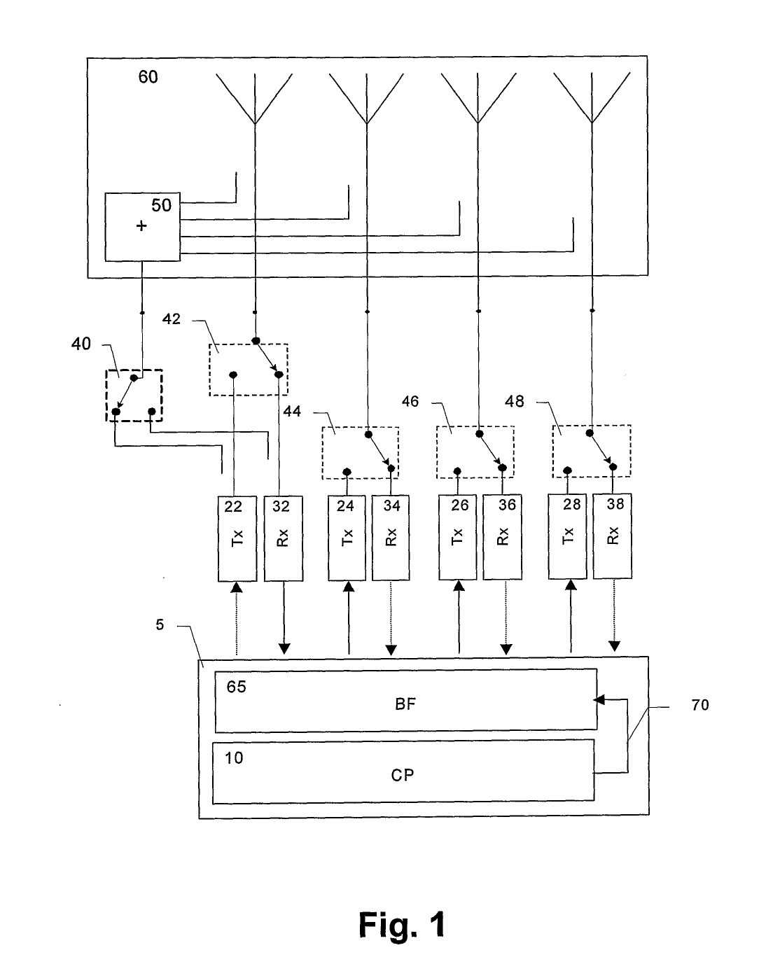

FIG. 1 shows an exemplary multi-antenna system according to the embodiment, wherein an antenna array or smart antenna 60 comprising four antenna elements are provided. A beamformer 65 may be implemented e.g. as part of a signal processing element. The multi-antenna system may be provided at a base station device or access device of a wireless or cellular network. As initially mentioned, the beamformer 65 is configured to adjust at least one of phases and amplitudes of respective signal components supplied to said smart antenna 60 in order to generate an antenna pattern with a predetermined directivity, e.g. beam or nulling direction. It is noted that FIG. 1 only shows those elements involved in or related to the proposed calibration procedures or mechanism. Other components have been omitted for reasons of clarity and brevity.

The beamformer 65 is controlled by a beamforming control signal or information 70 which is generated by a calibration processor 10. The calibration processor 10 and beamformer 65 are part of or integrated into the general signal generation/reception module 5. Blocks 5, 10, and 65 of FIG. 1 may be implemented as a digital processor, computer device, or analog processing circuit. The calibration processor 10 generates respective calibration signals for each of four transmission (Tx) chains 22, 24, 26, and 28 and, respectively, receives calibration signals from each of four receiving (Rx) chains 32, 34, 36, and 38. Each of the Tx chains 22, 24, 26, and 28 and Rx chains 32, 34, 36, and 38 is used for transmitting or respectively receiving a respective transmission signal component via a respective antenna element of the smart antenna 60. The Tx and Rx chains comprise a plurality of processing elements or stages (such as mixing stages, modulating or demodulating stages, filter stages, coding or decoding stages, amplifying stages, etc.) required for transmitting or receiving transmission signal components. Depending on an uplink or downlink calibration operation, respective switching elements 40, 42, 44, 46, and 48, which may be electrical or mechanical switches are switched by a control function (not shown) to a predetermined switching position.

In FIG. 1, the switching elements 42 to 48 are switched to the Rx chains 32, 34, 36, and 38, so that the antenna elements are connected to respective Rx chains 32, 34, 36, and 38 and the Rx chains 32, 34, 26, and 38 can be calibrated, which corresponds to an uplink calibration, assuming that FIG. 1 shows a smart antenna system of a base station or access station. The calibration can be achieved by providing a coupling path with an additional calibration switching element 40 and first coupling elements for coupling an output signal of the leftmost Tx chain 22 to the calibration switching element 40 and for coupling an output signal of the calibration switching element 40 to the leftmost Rx chain 32. Hence, the leftmost Tx and Rx chains 22, 32 are also used for providing the calibration coupling path, so that no separate processing chains are required for calibration. The calibration switching element 40 is connected to a combining or branching element 50 (e.g. passive power combiner/splitter or active electronic circuit) configured to combine downlink calibration signals transferred via the Tx chains 22, 24, 26, and 28 or to branch or distribute a calibration signal provided at the output of the calibration switching element 40 to the antenna elements of the smart antenna system 60.

In the uplink calibration state shown in FIG. 1, the calibration switching element 40 is connected to the left switching state and thus connects a calibration signal (dotted arrows), generated by the calibration processor 10 and forwarded through the leftmost Tx chain 22, via a respective one of the first coupling elements and the combining or distribution element 50 to respective second coupling elements provided in each signal path. The switching elements 42, 44, 46, and 48 are set to the right switching state, so that the calibration signal components are branched to the Rx chains 32, 34, 36, and 38, where they are received and supplied to the calibration processor 10 for measuring purposes. Hence, the beamformer 65 can be adjusted via the beamforming control information 70 to compensate for variations between individual ones of the Rx chains 32, 34, 36, and 38.

In the downlink calibration state (switching states opposite to those shown in FIG. 1), the calibration switching element 40 is connected to the right switching state and thus connects a calibration signal (solid arrows), supplied by the combining or distributing element 50 and forwarded through the leftmost Rx chain 32 to the calibration processor 10 for measuring purposes. The calibration signal is provided in a predetermined portion of the downlink transmission signal components and is coupled or branched off by the second coupling elements, combined at the combining or distribution element 50 and forwarded to the calibration switching element 40. As the switching elements 42, 44, 46, and 48 are now set to the left switching state, the calibration signal components generated at the calibration processor 10 and provided at the output of the Tx chains 22, 24, 26, and 28 are supplied to the second coupling elements and coupled to the combining or distributing element. Hence, the beamformer 65 can be adjusted via the beamforming control information 70 to compensate for delay variations between individual ones of the Tx chains 22, 24, 26, and 28.

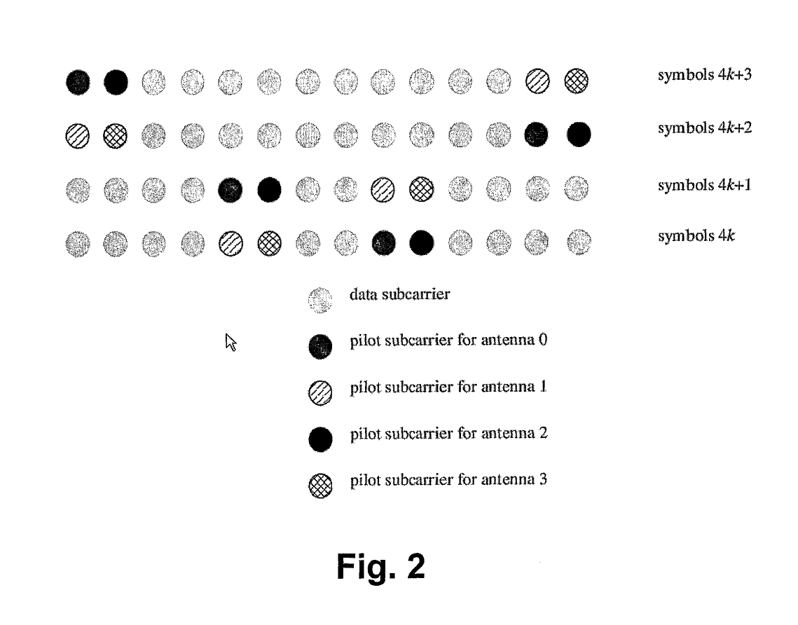

FIG. 2 shows a exemplary sequence of symbols with dedicated pilots for four antennas as defined in the IETF (Internet Engineering Task Force) specification 802.16e. These separate pilots which are specific to the four antenna elements can be used as signal portions available for transmitting the calibration signal, e.g., during downlink calibration.

According to FIG. 2, four different pilot subcarriers of an orthogonal frequency division multiplex (OFDM) signal are dedicated to specific ones of the four antenna elements of the smart antenna 60 of FIG. 1. The grey circular areas designate data subcarriers used for transmitting user data. Thus, four pilot subcarriout of a total of 14 subcarriers are provided in each symbol, wherein four successive symbols 4k to 4k+3 are shown in FIG. 2. the location of the four pilots change periodically with a period of four successive symbols. Of course, other patterns and numbers of pilots can be provided, e.g., depending on the number of antenna elements. During uplink reception, only one transmitter (e.g. Tx chain 22 of FIG. 1) feeds the calibration signal to all receivers (e.g. Rx chains 32, 34, 36, and 38 of FIG. 1), and thus the relative phase and amplitude errors in the receive chains can be determined by the calibration processor 10. During uplink calibration, the uplink reception path does not differ from that when no calibration happens. It is noted that the uplink calibration signal can be derived (by the second coupling elements) before a power amplifier (not shown) which may be provided at the smart antenna 60. All power amplifiers can be switched off during uplink calibration.

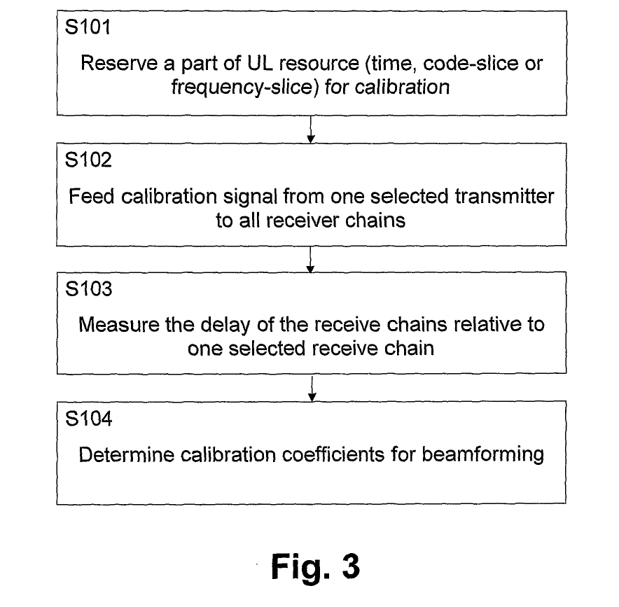

FIG. 3 shows a schematic flow diagram of basic steps involved in the uplink calibration procedure according to the embodiment, which may be controlled by the calibration processor 10.

In step S101, a piece of uplink resource (e.g. a time period, code-slice (code portion) or frequency-slice (subcarrier)) is reserved for calibration. Then, in step S102, a calibration signal is fed from the selected transmitter (e.g. Tx chain 22) via the first coupling elements, the calibration branch (including the calibration switching element 40 and the combining or distributing element 50), and the second coupling elements to all Rx chains 32, 34, 36, and 38. In step S103, the calibration processor 10 measures the delay, phase, and/or amplitude of the respective Rx chains 32, 34, 36, and 38 relative to a selected one of the Rx chains 32, 34, 36, and 38. Based on the measuring results, e.g., phase errors and/or amplitude errors of the Rx chains 32, 34, 36, and 38, the calibration processor 10 determines in step S104 calibration coefficients (as an example of the beamforming control information 70) to be used for beamforming.

During downlink transmission, the transmit signal is coupled by the second coupling elements after the transmitters (e.g. Tx chains 22, 24, 26, and 28 of FIG. 1) and fed via the calibration branch to the selected receiver (e.g. Rx chain 32 of FIG. 1 with all switching elements 40, 42, 44, 46, and 48 in inverse or opposite position). Thus, only one receiver measures all transmitters, and thus the calibration processor 10 can determine their relative amplitude and/or phase errors. The transmitters (e.g. Tx chains 22, 24, 26, and 28) can be distinguished through their characteristic transmission, e.g. that of the pilots particular to their antenna elements. Thus, the downlink transmission path during calibration does not differ from that when no calibration happens.

The distribution of the calibration signal to the array antennas can be done using couplers or a calibration antenna close to the antenna array.

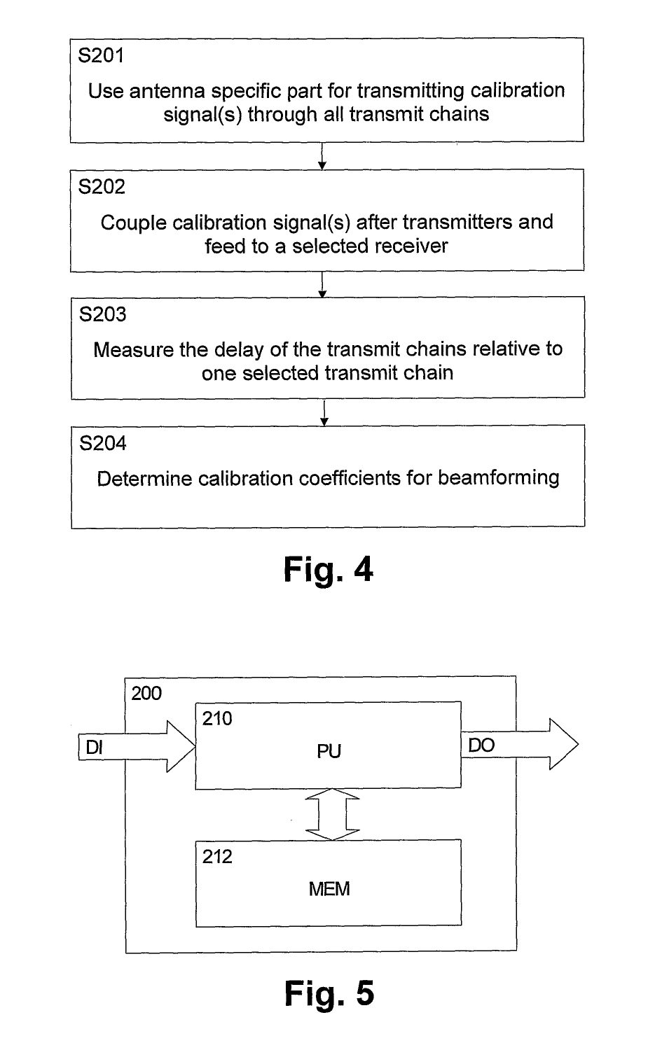

FIG. 4 shows a schematic flow diagram of basic steps involved in the downlink calibration procedure according to the embodiment, which may also be controlled by the calibration processor 10.

In step S201, an antenna (element) specific part or portion of the transmission signal (e.g. a pilot as shown in FIG. 2) is used for transmitting or discriminating calibration signals through all Tx chains 22, 24, 26, and 28. Then, in step S202, calibration signals are coupled by the second coupling elements and fed via the calibration branch and the first coupling elements to a selected receiver (e.g. Rx chain 32). In step S203, the calibration processor 10 measures the delay, phase, and/or amplitude of the respective Tx chains 22, 24, 26, and 28 relative to a selected one of the Tx chains 22, 24, 26, and 28. Based on the measuring results, e.g., phase errors and/or amplitude errors of the Tx chains 22, 24, 26, and 28, the calibration processor 10 determines in step S204 calibration coefficients (as an example of the beamforming control information 70) to be used for beamforming.

A calibration system can thus be provided, in which cell load could be determined and an uplink calibration may be performed at a time when the cell load permits to do so. The uplink calibration signal can be either a code from user space (e.g. code division multiple access (CDMA)), or occupies a time-frequency slice from normal uplink user allocations (OFDMA). The Rx chains can be calibrated during regular uplink reception. In downlink calibration, antenna-specific signal parts or portions (e.g. pilots) of a regular downlink transmission can be used to calibrate the Tx chains. The calibration may be performed during downlink transmission, when no UL reception is required.

FIG. 5 shows a schematic block diagram of a software-based implementation of the proposed calibration system. Here, the calibration processor 10 is configured as a computer device 200 comprises a processing unit 210, which may be any processor or processing device with a control unit which performs control based on software routines of a control program stored in a memory 212. Program code instructions are fetched from the memory 212 and are loaded to the control unit of the processing unit 210 in order to perform the processing steps of the above functionalities described in connection with the respective FIGS. 3 and 4. These processing steps may be performed on the basis of input data DI and may generate output data DO, wherein the input data DI may correspond to the measured delay values of the Rx or Tx chains and the output data DO may correspond to the beamforming control information 70 (e.g. calibration coefficients).

At this point, it is noted that the functionalities of the calibration processor 10 of FIG. 1 can be implemented as discrete hardware or signal processing units, or alternatively as software routines or programs controlling a processor or computer device to perform the processing steps of the above functionalities. The measuring algorithm implemented in a software routine then measures the delay, phase, and/or amplitude of the Rx and/or Tx chains relative to one selected chain and provides calibration coefficients for the beamforming algorithm.

To summarize, a method, system, apparatus, and computer program product have been described for transmitting or receiving a plurality of time-duplexed transmission signal components via respective transmission or reception chains and respective antenna elements of a smart antenna system. A calibration signal is temporarily coupled into or from the transmission or reception chains via a selected one of the transmission or reception chains by using a portion of the transmission signal components, and a calibration signal delay, phase, and/or amplitude distortion, caused by said transmission or reception chains, is measured relative to a selected one of the transmission or reception chains. Then, a beamforming process of said smart antenna system is calibrated in response to a result of the measuring. Thereby, calibration can be implemented at low complexity.

It is to be noted that the present invention is not restricted to the embodiment described above, but can be implemented in any network environment involving multi-antenna systems with a beamforming functionality. Any delay and/or amplitude measuring approach (e.g. based on a correlation function with subsequent peak measurements, a counting or timer function, etc.) can be used for evaluating and comparing the received calibration signal(s). The embodiment may thus vary within the scope of the attached claims.

1-35. (canceled)

36. A method comprising:
performing at least one of transmitting and receiving an orthogonal frequency division multiplex signal via a plurality of antenna elements;
performing at least one of transmitting and receiving an orthogonal frequency division multiplex signal via one of at least one transmission chain and at least one reception chain;
performing at least one of coupling the orthogonal frequency division multiplex signal via a switchable signal path from at least one transmission chain to at least one reception chain and coupling the orthogonal frequency division multiplex signal via a switchable signal path into at least one reception chain from at least one transmission chain;
performing the at least one coupling by providing a calibration signal, the calibration signal being provided in a predetermined portion of the orthogonal frequency division multiplex signal;
measuring the calibration signal relative to at least one of at least one transmission chain and at least one reception chain to provide beamforming control information; and
calibrating the plurality of antenna elements with the beamforming control information.

37. The method according to claim 36, wherein the predetermined portion of the orthogonal frequency division multiplex signal is at least one of a time period, a code slice and a frequency slice.

38. The method according to claim 37, wherein the orthogonal frequency division multiplex signal is at least one of an uplink orthogonal frequency division multiplex signal and a downlink orthogonal frequency division multiplex signal.

39. The method according to claim 36, wherein the portion of the orthogonal frequency division multiplex signal is a portion specific to at least one of the plurality of antenna elements, and wherein the portion specific to at least one of the plurality of antenna elements is a pilot signal.

40. The method according to claim 36, wherein the calibrating comprises generating calibration coefficients for a beamforming algorithm.

41. The method according to claim 36, wherein the coupling is performed prior to power amplification of the orthogonal frequency division multiplex signal.

42. The method according to claim 41, further comprising switching off the power amplification during uplink calibration.

43. The method according to claim 36, wherein the coupling is performed by using at least one of at least two couplers and at least one calibration antenna in proximity to each one of the plurality of antenna elements.

44. The method according to claim 36, further comprising determining a cell load and performing uplink calibration in dependence on the result of the determination.

45. The method according to claim 36, wherein for uplink calibration, the calibration signal is at least one of a noise signal and a regular user signal.

46. An apparatus comprising:
a plurality of transmission chains and a plurality of reception chains;
a plurality of antenna elements;
at least one of at least one transmission chain configured to transmit an orthogonal frequency division multiplex signal via at least one antenna element and at least one reception chain, and at least one reception chain configured to receive an orthogonal frequency division multiplex signal via at least one antenna element and at least one transmission chain;
coupling elements arranged to couple at least one of the orthogonal frequency division multiplex signal via a switching element from at least one transmission chain to at least one reception chain, and the orthogonal frequency division multiplex signal via a switching element to at least one reception chain from at least one transmission chain, wherein a calibration signal is provided in a predetermined portion of the orthogonal frequency division multiplex signal;
a measuring unit configured to measure the calibration signal relative to at least one of at least one transmission chain and at least one reception chain, the measuring unit configured to provide beamforming control information; and
a calibration unit configured to calibrate the plurality of antenna elements with the beamforming control information.

47. The apparatus according to claim 46, wherein the predetermined portion of the orthogonal frequency division multiplex signal is at least one of a time period, a code slice and a frequency slice.

48. The apparatus according to claim 47, wherein the orthogonal frequency division multiplex signal is at least one of an uplink orthogonal frequency division multiplex signal and a downlink orthogonal frequency division multiplex signal.

49. The apparatus according to claim 46, wherein the predetermined portion of the orthogonal frequency division multiplex signal is a portion specific to at least one of the plurality of antenna elements, and wherein the portion specific to at least one of the plurality of antenna elements is a pilot signal.

50. The apparatus according to claim 46, wherein the calibration unit is configured to generate calibration coefficients for a beamforming algorithm.

51. The apparatus according to claim 46, wherein the coupling elements are arranged prior to power amplification of the orthogonal frequency division multiplex signal.

52. The apparatus according to claim 51, wherein the apparatus is configured to switch off the power amplification during uplink calibration.

53. The apparatus according to claim 46, wherein the coupling elements comprise at least one of at least two couplers and at least one calibration antenna close to each one of the plurality of antenna elements.

54. The apparatus according to claim 46, wherein the apparatus is configured to determine a cell load and to perform uplink calibration in dependence on the result of the determination.

55. The apparatus according to claim 46, wherein the apparatus is configured to provide the calibration signal as at least one of a noise signal and a regular user signal, during uplink calibration.

56. A computer program product comprising code means for producing the method of claim 36 when run on a computer device.

57. A base station device comprising an apparatus according to claim 46.
